(19) United States
(12) Patent Application Publication
(10) Pub. No.: US 2012/0081550 A1
(43) Pub. Date: Apr. 5, 2012

(54) CAMERA SYSTEM

(75) Inventor: Michael Roland Sewell, Ontario (CA)

(73) Assignee: TK Holdings Inc.

(21) Appl. No.: 13/251,857

(22) Filed: Oct. 3, 2011

Related U.S. Application Data
(60) Provisional application No. 61/389,553, filed on Oct. 4, 2010.

(51) Int. Cl. H04N 7/18

(52) U.S. Cl. 348/148; 348/E07.085

(57) ABSTRACT

A camera system comprising a circuit board having a first end with a first camera electrically connected thereto and a second end with a second camera electrically connected thereto; and a frame having a first frame member, a second frame member, and a mount for attaching the system to the vehicle; wherein the circuit board is disposed between the first and second frame members; and wherein the first frame member is coupled to the second frame member at a first connection location proximate the first end and at a second connection location proximate the second end to reduce the deflection of the first and second ends of the circuit board relative to the mount to maintain the alignment of the first and second cameras.

### CROSS-REFERENCE TO RELATED PATENT APPLICATIONS

The present application claims the benefit of and priority to U.S. Provisional Patent Application No. 61/389,553 filed on Oct. 4, 2010. The foregoing provisional application is incorporated by reference herein in its entirety.

### BACKGROUND

The present application relates generally to the field of camera systems. More specifically, the application relates to camera systems having improved mounting systems.

Circuit boards for stereo vision cameras are typically mounted on a single metal frame. The single metal frame creates the potential for differential expansion between the frame (or housing) and the board as temperature changes. The differential expansion causes the assembly to warp, which may cause misalignment between two cameras mounted on the circuit board.

Some sensor designs use multiple board assemblies with the cameras mounted on separate boards to control relative movement from thermal expansion. By mounting each camera on a separate board and using a heavy main frame the problem of differential thermal expansion and of thermal misalignment of the cameras may be minimized. However, such a multiple board assembly has a high cost, complexity, and potential misalignment should the fasteners holding the two separate camera boards in place loosen. It may also be difficult to reduce the size of the camera module when using multiple board assemblies.

What is needed is a system that allows use of a single circuit board system while reducing or eliminating camera misalignment caused by differential thermal expansion.

### SUMMARY

One embodiment disclosed relates to a camera system for use in a vehicle. The camera system includes a circuit board having a first end with a first camera electrically connected thereto and a second end with a second camera electrically connected thereto. The camera system also includes a frame having a first frame member, a second frame member, and a mount for attaching the camera system to the vehicle. The circuit board is disposed between the first and second frame members, and the first frame member is coupled to the second frame member at a first connection location proximate the first end and at a second connection location proximate the second end to reduce the deflection of the first and second ends of the circuit board relative to the mount to maintain the alignment of the first and second cameras.

Another embodiment disclosed relates to a mounting system for mounting a circuit board of a camera system, the circuit board having a portion configured to have at least one camera electrically connected thereto. The mounting system includes a first frame member, a second frame member, and a mount for attaching the mounting system to the vehicle. The first frame member is coupled to the second frame member through at least one connection location, such that the circuit board is disposed between the first and second frame members, and the at least one connection location is proximate to the at least one camera to reduce the deflection of the portion of the circuit board relative to the mount.

### BRIEF DESCRIPTION OF THE DRAWINGS

These and other features, aspects, and advantages of the present invention will become apparent from the following description and the accompanying exemplary embodiments shown in the drawings, which are briefly described below.

FIG. 1 is a perspective view of a camera system having a single frame, according to an exemplary embodiment.

FIG. 2 is a perspective view of the system of FIG. 1 illustrating the warping or deflection of the system caused by thermal stress.

FIG. 3 is a perspective view of a camera system having a two-member frame, according to another exemplary embodiment.

FIG. 4 is a perspective view of the camera system of FIG. 3 illustrating the warping or deflection of the system caused by thermal stress.

FIG. 5 is a perspective view of a cover for a camera system, according to an exemplary embodiment.

FIG. 6 is a perspective view of a housing for a camera system, according to an exemplary embodiment.

FIG. 7 is an exploded view of a camera system including a housing and cover to control warp of the circuit board, according to another exemplary embodiment.

FIG. 8 is a perspective view of a camera system having sliding connections, according to an exemplary embodiment.

FIG. 9 is an exploded perspective view of the system of FIG. 8.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the figures, a single circuit board design may be implemented that is configured to reduce warping of the circuit board by thermal expansion. In one exemplary embodiment, the circuit board may be mounted rigidly on a frame to constrain regions where the imagers or cameras are located. In another exemplary embodiment, a second frame member may be mounted on the opposite side of the circuit board from a first frame member to generate a counteracting force to reduce or prevent the warping motion or deflection of the circuit board. In another exemplary embodiment, the circuit board may be mounted on a frame in a manner that allows the board to slide independent of the expansion of the frame material. Such a sliding configuration may reduce or prevent warping of the board by not permitting force generation. In another exemplary embodiment, the expansion coefficient (e.g., coefficient of thermal expansion) of the circuit board may be determined and the frame and/or housing may be made from a material that has the same or similar expansion coefficient as the material comprising the board. Such a material selection may act to reduce or minimize the forces on the board and thus reduce or minimize warping.

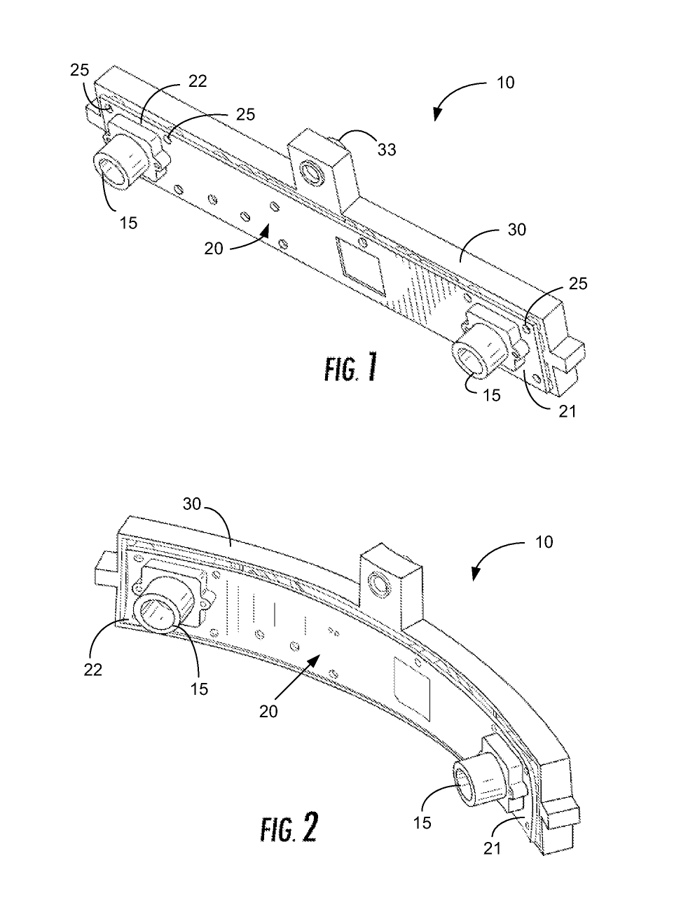

FIG. 1 illustrates a camera system 10 (e.g., a stereo camera system) that includes two cameras 15 mounted on a printed circuit board 20, according to an exemplary embodiment. The circuit board 20 is mounted to a frame 30 at one or more connection 25, where the frame 30 is used to attach the camera system 10 to a vehicle or stationary object at the mount 33 and to stabilize the circuit board 20 against vibration. The frame 30 may be made of aluminum or any other suitable material, such as a material that helps stabilize the circuit board 20. The cameras 15 are mounted on opposite ends of the circuit board 20 in order to provide a larger field of view and improved depth perception. As shown, the circuit board 20 has an elongated shape having a first end 21 and a second end 22, where each of the first and second ends 21, 22 are configured to have a camera 15 electrically connected thereto. In other exemplary embodiments, the cameras 15 may be located at any position on the circuit board 20, and more than or fewer than two cameras 15 may be used. According to various exemplary embodiments, the cameras 15 may be any camera, image sensing device, or imaging chip. The camera system 10 having a single frame 30 is illustrated in FIG. 1 at an ambient temperature of about 25 degrees Celsius or other relatively moderate temperature at which differential thermal expansion may not occur.

As shown in FIG. 2, thermal expansion of the single frame 30 and circuit board 20 may cause excessive warp. The single frame camera system 10 of FIG. 1 is illustrated in FIG. 2 at a temperature of about 85 degrees Celsius or another temperature at which thermal expansion may occur. The frame 30 and circuit board 20 may warp due to the frame 30 having a different amount of thermal expansion (e.g., deflection) relative to the thermal expansion of the circuit board 20 caused primarily because the circuit board 20 and frame 30 have different thermal expansion properties (e.g., the coefficient of thermal expansion). The warping may cause the cameras 15 (e.g., the lenses of the cameras) to move out of alignment from their preset aiming positions. The misalignment of the cameras 15 may prevent the camera system 10 from generating accurate information. The effect of warping may be most severe with respect to measuring the distance from the mounting location to an object.

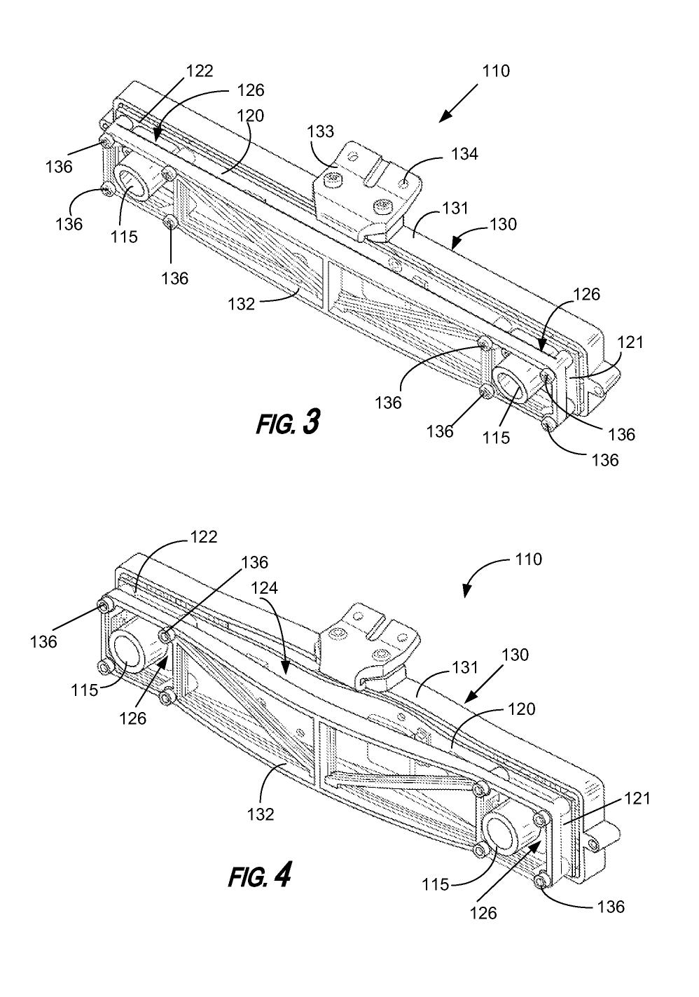

FIG. 3 illustrates a camera system 110 that includes features that may reduce or prevent the tendency of the printed circuit board 120 to warp under thermal changes when the circuit board 120 is firmly attached to a frame 130 (e.g., a chassis). While warping of the circuit board 120 may not be completely prevented under all circumstances, the camera system 110 may be configured to minimize warp and control the portion of the circuit board 120 where the effects of warping will be most evident or damaging, such as the one or more than one portion of the circuit board 120 that is connected to the one ore more than one camera. For a stereo camera application, the frame 130 of the camera system 110 may be configured to control the movement of the cameras 15.

As shown, the camera system 110 includes two cameras 115, a circuit board 120, and a mounting frame 130 having a first frame member 131 (e.g., mounting frame member) and a second frame member 132 (e.g., stabilizing frame member). The two cameras 115 are mounted on a single circuit board 120 and may be aligned for optimal image sensing performance. The circuit board 120 has an elongated shape having a first end 121 with a first camera 115 electrically connected thereto and a second end 122 with a second camera 115 electrically connected thereto. The circuit board 120 is interposed the first and second frame members 131, 132, and the circuit board 120 may be mounted on or coupled to the first frame member 131 and/or second frame member 132. The first frame member 131 may be coupled to the second frame member 132 through connection locations 136. Each connection location 136 may include a fastener (e.g., screw, bolt, etc.) that couples the first frame member 131 to the second frame member 132 thereby clamping a connecting portion of the circuit board 120 between the first and second frame members 131, 132. Each frame member 131, 132 may include a connecting feature for each connection location 136, such as a shoulder having a hole, where the shoulder supports an abutting portion of the circuit board 120, and where the hole may receive a fastener or other suitable connecting element.

The camera system 110 is configured to mount to a vehicle or stationary location via a mounting point. For example, a mount 133 may connect the camera system 110 to a vehicle or other object, where the mount 133 may be integrally formed with the first frame member 131 or may be formed separately and coupled to the first frame member 131 using any suitable connecting method (e.g., welding, fasteners, etc.). The mount 133 may include an opening 134 (e.g., a mounting point, a mounting location) to receive a fastener to couple the camera system 110 to the vehicle, or may utilize any suitable method for coupling the camera system 110 to the vehicle. Alternatively, the mount 133 may include a plurality of mounting locations 134.

The first frame member 131 may have an elongated rectangular shape or any suitable shape, which may be generally solid, or may comprise a plurality of external walls with one or more support members (e.g., trusses, ribs) extending between the walls to provide structural support. The ends of the first frame member 131 may be configured to be coupled to the ends of the second frame member 132 and/or the circuit board 120, such as through connections.

The second frame member 132 may also have an elongated rectangular shape or any suitable shape, which may be generally solid, or may comprise a plurality of external walls with one or more support members (e.g., trusses, ribs) extending between the walls to provide structural support. The ends of the second frame member 132 may be configured to be coupled to the ends of the first frame member 131 and/or the circuit board 120, such as through connections. The ends of the second frame member 132 may also include an aperture configured to receive the camera (e.g., the lens of the camera).

The second frame member 132 (e.g., stabilizing frame member) may be made from the same material or from a material having a similar coefficient of thermal expansion as the first frame member 131 (e.g., mounting frame member), in order for the second frame member 132 to expand at the same (or similar) rate as the first frame member 131. The second frame member 132 may be secured to an opposing side or face of the circuit board 120 relative to the first frame member 131. Accordingly, the expansion of the second frame member 132 at the front of the circuit board 120 may reduce warping or twisting of the circuit board 120 because the movement of the front and back of the circuit board 120 is balanced.

The second frame member 132 may be capable of providing adequate force to balance the resultant force of expansion of the first frame member 131 and/or the circuit board 120. The balance may be achieved by making the frames identical, but the use of identical frames on both sides of the board may add weight and size to the camera system 10. For example, the second frame member 132 may have a curved beam geometry to limit the amount of material used to provide the balancing force. The resulting camera system 110 may have very little misalignment of the cameras 115 over a wide range of operating temperatures (e.g., between about −40 C and about 85 C) and be relatively small and have a low weight.

The effect of warping may be most severe with respect to measuring the distance from the mounting location to an object. The use of the two-member frame 130 maintains high performance and accurate measurement over the entire operational temperature range of the camera system 110. Weight of the camera system 110 may be kept to a minimum to improve durability of the system to a vehicle windshield or other location.

FIG. 4 illustrates the camera system 110 of FIG. 3 with warping or deflection from thermal stress, showing that the two-member frame 130 does significantly reduce the amount of misalignment between cameras 115 (e.g., imager chips). Use of a two-member frame 130 in the camera system 110 may almost eliminate the warp of the circuit board 120 in the areas where the cameras 115 are mounted, such as at the portions of the first and second frame members 131, 132 that are adjacent to the first and second ends 121, 122 of the circuit board 120, while allowing the circuit board 120 to flex at other locations, such as at a flexing portion 124 located between the first and second ends 121, 122. The flexing portion 124 of the circuit board is isolated from the imagers or cameras 115 by the frame 130 (e.g., the first and second frame members 131, 132). The flexing portion 124 of the circuit board 120 may show a limited amount of warping under thermal stress, while camera mounting portions 126 of the circuit board 120 may remain relatively flat under thermal changes. As shown, the camera mounting portions 126 may be located at the first and second ends 121, 122, where the connection location 136 helps maintain the flatness of the first and second ends 121, 122 relative to the flexing portion 124. The two-member frame 130 of the camera system 110 may keep the cameras 115 more accurately aimed for better imaging performance between temperatures of about −40 C to 85 C. The two-member frame 130 may also reduce warping at temperature below −40 C and above 85 C.

In some exemplary embodiments, such as, for example, the two-member frame 130, the first and second frame members 131, 132 of the camera system 110 may be made of a material with thermal expansion properties similar to those of the circuit board 120. For example, one or both of the first and second frame members 131, 132 may be made of bulk-molding compound (BMC), aluminum silicon carbide, or another material having thermal properties similar to that of the circuit board 120. Such a configuration may enhance the effectiveness of the stabilizing frame 130 and may reduce the stress on the circuit board 120 caused by thermal expansion. In certain embodiments, the second frame member 132 may also be omitted to further reduce the size and weight of the camera system, such as with camera system 10 while providing a reduction in warping and twisting, such as by having the mounting frame 30 made from a material having similar thermal expansion properties as the circuit board 20.

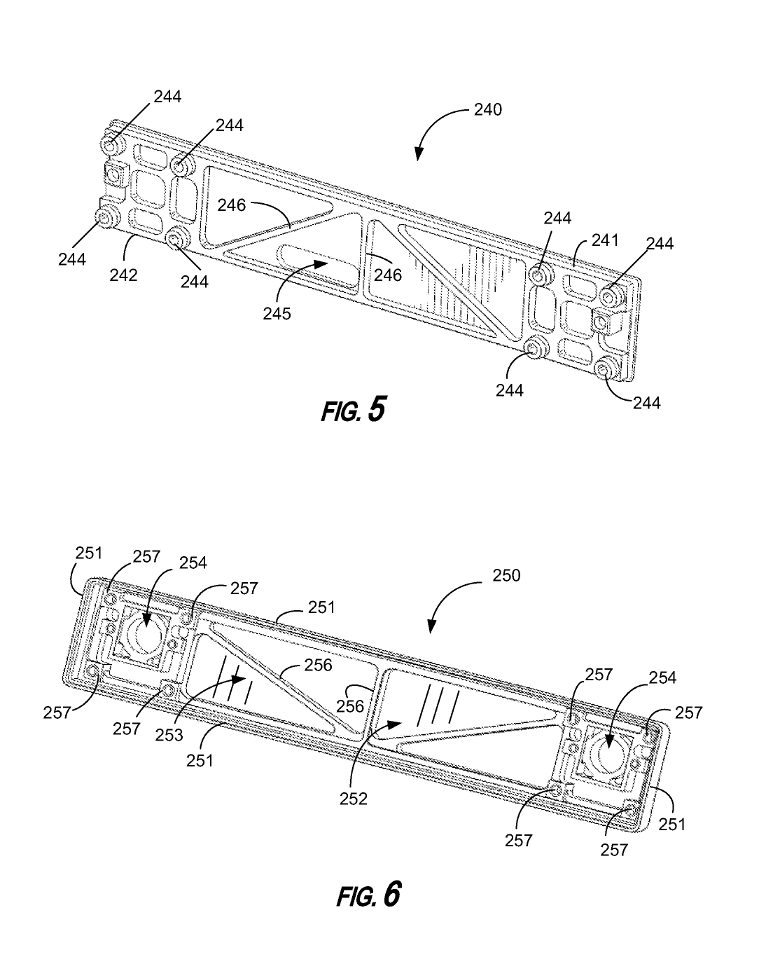

Now turning to FIGS. 5-7, it may be desirable for a camera system to protect the circuit board, the cameras, or other system components against external contaminants. For example, the camera system may be configured to protect the circuit board from exposure to liquid. The camera system may include a housing and/or a cover to protect the camera system, such as the circuit board, from exposure to potentially damaging elements (e.g., liquids). The housing and cover may be configured to protect the circuit board and/or frame by at least partially enclosing the circuit board and/or frame. For example, the housing and cover may together surround the circuit board to prohibit ingress of fluids or liquids into the camera system, as the liquids or fluids may adversely impact performance of the system.

As shown in FIG. 5, the cover 240 has an elongated rectangular shape that is configured to be received by a similar shaped opening 252 defined by walls 251 of the housing 250 (shown in FIG. 6). The cover 240 includes a first end 241 configured to support the first end 221 of the circuit board 220 and a second end 242 configured to support the second end 222 of the circuit board 220. The ends 241, 242 of the cover 240 include one or more than one connection location 244. As shown, each end 241, 242 includes four connection locations 244 as cylindrical shoulders, where each connection location 244 is configured to receive a fastener or other suitable coupling member to couple the cover 240 to the housing 250 and/or the circuit board 220. The cover 240 may also be configured to couple to the frame, such as frame 130, if the camera system 210 includes a frame. The cover 240 may include a hole 245, such as the slot 245 shown in FIG. 5, or any suitably shaped hole, to allow electrical connections to pass through the cover 240 to electrically connect the circuit board 220, such as to the electric power of the vehicle. The cover 240 may also include one or more supports 246 (e.g., frame members) for structural support. The supports 246 may be configured as ribs or have any suitable configuration to increase the strength of the cover 240.

As shown in FIG. 6, the walls 251 of the housing 250 define a cavity 253 having the opening 252 which receives the cover 240. The cavity 253 is configured to house the circuit board 220, as well as the frame if provided. The housing 250 includes a lens holder 254 that allows a camera to protrude through the housing 250. As shown, the housing 250 includes a lens holder 254 disposed on each end thereof, where each lens holder 254 receives and supports one of the two cameras (not shown) of the camera system 210. Each lens holder 254 may be configured as a socket with a bore, the socket configured to receive the body of the camera and the bore configured to receive the lens of the camera. The housing 250 may also include one or more supports 256 (e.g., frame members) for structural support. The supports 256 may be configured as ribs or have any suitable configuration to increase the strength of the housing 250. The housing 250 may also include one or more than one connection location 257 configured to couple the housing 250 to the cover 240 and/or the circuit board 220. For example, the connection location 257 may include a hole that is configured to receive a fastener (e.g., screw, bolt) coupling the housing 250 to the cover 240 through the circuit board 220.

The cover 240 and housing 250 may be made of plastic or any other suitable material, such as another light (e.g., weight) material. The light weight cover 240 and housing 250 may be configured so that the cover 240 and housing 250 do not interfere with thermal movement or expansion of the frame (e.g., the first and second frame members 231, 232) and/or circuit board 220. Either alone or in combination, the cover 240 and housing 250 may protect the circuit board 220, cameras, or other components of the system.

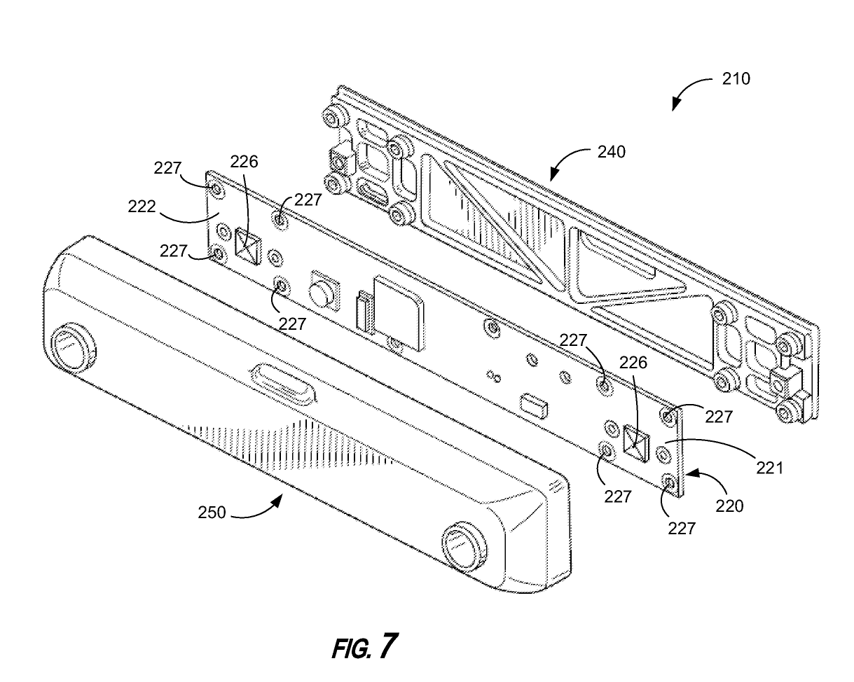

As shown in FIG. 7, the housing 250 and/or cover 240 may be configured to control the effects of thermal expansion on the camera system 210. Elements of the frame (e.g., the first and second frame members) may be designed into the housing 250 and cover 240, such that the camera system 210 may be configured without the frame. Curved geometry may not be required in this embodiment to reduce warping of the circuit board 220 in areas or portions near or around the camera mounts 226 (e.g., camera mounting portions), where the cameras (not shown) mount to the circuit board 220. In other words, a two-member frame system may also be produced using the housing 250 and cover 240 as the two-frame elements (e.g., the first and second frame members) so that the housing 250 and/or cover 240 provide a compensating method against warping of the circuit board 220. As shown, the circuit board 220 includes four connection locations 227 disposed on each of the first and second ends 221, 222, where each set of four connection locations 227 are configured in a rectangular pattern around one of the two camera mounts 226 to provide stability to the ends 221, 222 of the circuit board 220 to thereby maintain alignment between the two cameras. Each connection location 227 may be configured as a shoulder having a hole, where the shoulder receives support, such as from a mating shoulder on the cover 240 and/or the housing 250, and where the hole may receive a fastener or other suitable coupling member.

The preceding exemplary embodiments disclose that the board may be firmly clamped, such as to the frame or to the housing and/or cover. For example, the board may be firmly clamped to the frame at each connection (e.g., attachment point) so that the board is firmly fixed to the frame (e.g., a frame member) and therefore moves with the frame at the connection, in the event of any such movement. Such fixed connections or attachment configurations control the warp at the camera positions (e.g., camera mounts) and may be less complicated to construct, however, may also, under some circumstances, impose thermal stress on the printed circuit board.

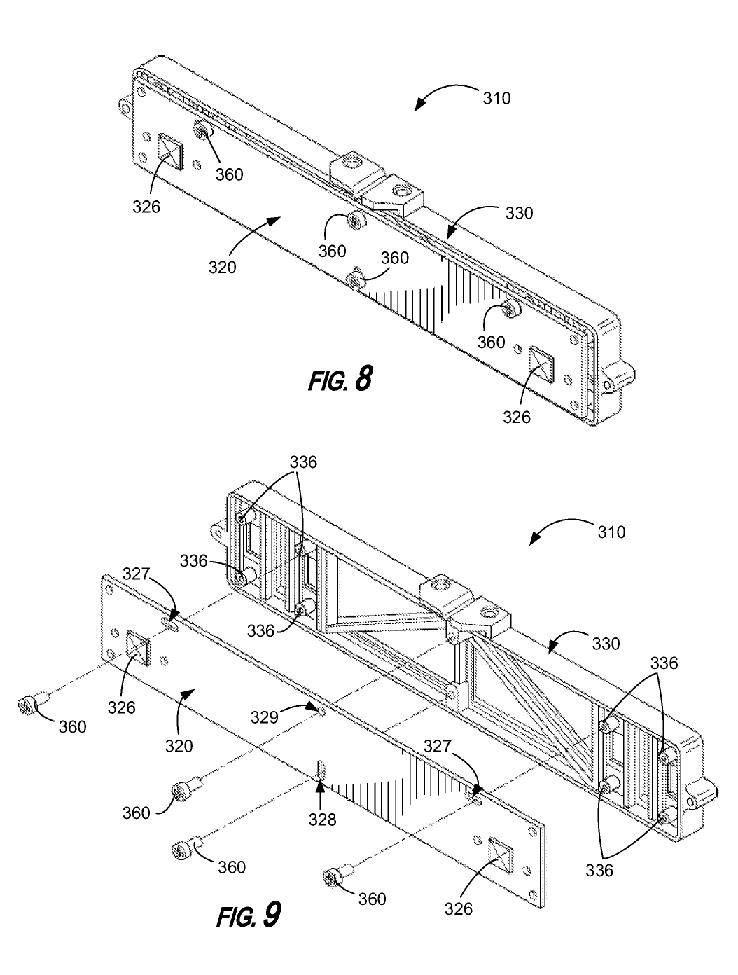

FIGS. 8 and 9 illustrate a camera system 310 configured to reduce or eliminate thermal stress on the circuit board 320. According to an exemplary embodiment, the circuit board 320 is allowed to “float” or move relative to a supporting frame 330 so that thermal stresses are not induced (i.e., do not develop). The frame 330 may be rigidly configured to position and support the circuit board 320. For example, the frame 330 may include one or more supports 336 configured to abut the circuit board 320 to support the area of the circuit board 320 local to each support 336. Each support 336 may also include a bore or other feature configured to receive a fastener 360, such as to couple the circuit board 320 and the frame 330. However, the circuit board 320 is slotted to allow movement of certain portions of the circuit board 320 relative to the frame 330 to relieve stress, while maintaining the shape of camera mounts 326 to thereby hold the cameras (not shown) in the desired alignments or orientations. As shown in FIG. 9, the circuit board 320 includes two horizontally extending slots 327 (e.g., holes) and a vertically extending slot 328 (e.g., hole), where each slot 327, 328 allows the portion of the circuit board 320 local (e.g., near, adjacent) the slot 327, 328 to move relative to the frame 330, to allow the stresses (e.g., thermal stresses) to be relieved when the camera system 310 is exposed to extreme (e.g., high, low) temperatures. Each slot 327, 328 is configured to receive a fastener 360 that slideably couples the circuit board 320 to the frame 330. Alternatively, the circuit board 320 may include any number of horizontal slots 327 and/or any number of vertical slots 328, where the locations of the slots may be varied, such as to locations on the circuit board 320 provided farther away from the camera mounts 326. As shown, the circuit board 320 may also include a hole 329 configured to firmly fix the circuit board 320 to the frame 330 at the position of the hole 329, such as by another fastener 360 that prohibits movement of the portion of the circuit board 320 near the hole 329 relative to the frame 330. The slots 327, 328 in the circuit board 320 allow movement (e.g., linear movement) of the circuit board 320 relative to the frame 330. Additionally, the fasteners 360 that engage the slots 327, 328 at the sliding connections may be driven-in (e.g., tightened) with a reduced torque to provide a reduced clamping load in order to minimize the frictional force between the circuit board 320 and the frame 330. The fasteners 360 may include, for example, conventional screws, spring loaded fasteners for controlling the normal force at the slotted locations, or any other fasteners.

The camera system 310 having sliding connections between the circuit board 320 and the frame 330 may reduce warp and reduce thermal stress on the circuit board 320. Both the normal force and the frictional force are controlled at the circuit board mounting positions or locations. Frictional force may be minimized to allow movement in the plane in which the circuit board 320 is configured in. The circuit board 320 may be any suitable board having a high degree of flatness. The circuit board 320 is fixed against horizontal movement at the vertical movement slot but is allowed to move vertically. The board is fixed against vertical movement at the one or more horizontal movement slots 327, but is allowed horizontal movement. While a specific number of vertical and horizontal movement slots 327, 328 are shown in the circuit board 320, in other exemplary embodiments, any number of vertical and horizontal movement slots 327, 328 may be used in the board. The vertical and horizontal movement slots 327, 328 may be positioned at various locations on the circuit board 320, which may vary from the locations shown in FIGS. 8 and 9.

Although the camera systems are illustrated as including multiple features utilized in conjunction with one another, each system may alternatively utilize more or less than all of the noted mechanisms or features shown in any of the camera systems shown or described herein. For example, in other exemplary embodiments, more or fewer connections (e.g., mounting locations) may be used in the system.

Although specific shapes of each element have been set forth in the drawings, each element may be of any other shape that facilitates the function to be performed by that element. For example, the cameras have been shown to be round or cylindrical, however, in other exemplary embodiments the structure may define cameras or imaging chips of other shapes.

For purposes of this application, the term “coupled” means the joining of two components (electrical, mechanical, or magnetic) directly or indirectly to one another. Such joining may be stationary in nature or movable in nature. Such joining may be achieved with the two components (electrical or mechanical) and any additional intermediate members being integrally defined as a single unitary body with one another or with the two components or the two components and any additional member being attached to one another. Such joining may be permanent in nature or alternatively may be removable or releasable in nature

The present application has been described with reference to example embodiments, however persons skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. Other substitutions, modifications, changes and omissions may be made in the design, operating conditions and arrangement of the preferred and other exemplary embodiments without departing from the spirit of the present subject matter.

What is claimed is:

1. A camera system for a vehicle, comprising:
a circuit board having a first end with a first camera electrically connected thereto and a second end with a second camera electrically connected thereto; and
a frame having a first frame member, a second frame member, and a mount for attaching the system to the vehicle;
wherein the circuit board is disposed between the first and second frame members; and
wherein the first frame member is coupled to the second frame member at a first connection location proximate the first end and at a second connection location proximate the second end to reduce the deflection of the first and second ends of the circuit board relative to the mount to maintain the alignment of the first and second cameras.

2. The camera system of claim 1, wherein the first frame member and the second frame member are made from materials having similar coefficients of thermal expansion.

3. The camera system of claim 1, wherein the mount is located between the first and second connection locations.

4. The camera system of claim 3, wherein the first and second frame members are made from aluminum silicon carbide.

5. The camera system of claim 1, wherein the second frame member has a curved beam geometry.

6. The camera system of claim 1, further comprising a housing configured to at least partially enclose the circuit board and frame, the housing having a first aperture configured to receive a lens of the first camera and a second aperture configured to receive a lens of the second camera.

7. The camera system of claim 6, further comprising a cover configured to be coupled to the housing to at least partially enclose the coupled circuit board and frame.

8. The camera system of claim 1, wherein the first frame member is configured as a housing and the second frame member is configured as a cover, the cover being coupled to the housing to enclose at least a portion of the circuit board therein.

9. The camera system of claim 1, wherein at each of the connection locations the frame members are attached at a plurality of locations that are configured to at least partially surround one of the first and second cameras, and wherein at each of the plurality of locations the circuit board is connected to the frame.

10. The camera system of claim 1, wherein the circuit board includes at least one elongated opening configured to slideably couple the circuit board to the frame through the at least one connection location.

11. A mounting system for mounting a circuit board of a camera system, the circuit board having a portion configured to have at least one camera electrically connected thereto, the mounting system comprising:
a first frame member;
a second frame member; and
a mount for attaching the mounting system to the vehicle;
wherein the first frame member is coupled to the second frame member through at least one connection location, such that the circuit board is disposed between the first and second frame members; and
wherein the at least one connection location is proximate to the at least one camera to reduce the deflection of the portion of the circuit board relative to the mount.

12. The mounting system of claim 11, wherein the first frame member and the second frame member are made from materials having similar coefficients of thermal expansion.

13. The mounting system of claim 11, wherein the first frame member is coupled to the second frame member at a second connection location proximate to a second portion of the circuit board having a second camera electrically connected thereto, and wherein the mount is located between the first and second connection locations.

14. The mounting system of claim 13, wherein the first and second frame members are made from aluminum silicon carbide.

15. The mounting system of claim 11, wherein the second frame member has a curved beam geometry.

16. The mounting system of claim 11, further comprising a housing configured to at least partially enclose the circuit board and frame, the housing having an aperture configured to receive a lens of the at least one camera.

17. The mounting system of claim 16, further comprising a cover configured to be coupled to the housing to at least partially enclose the coupled circuit board and frame.

18. The mounting system of claim 11, wherein the first frame member is configured as a housing and the second frame member is configured as a cover, the cover being coupled to the housing to enclose at least a portion of the circuit board therein.

19. The mounting system of claim 11, wherein at each of the at least one connection location the frame members are attached at a plurality of locations that are configured to at least partially surround the at least one camera, and wherein at each of the plurality of locations the circuit board is connected to the frame.

20. The mounting system of claim 11, wherein the circuit board includes at least one elongated opening configured to slideably couple the circuit board to the frame through the at least one connection location.
